(19) United States
(12) Patent Application Publication
(10) Pub. No.: US 2012/0268558 A1
(43) Pub. Date: Oct. 25, 2012

(54) METHOD AND APPARATUS FOR VIDEO ENCODING USING INTER LAYER PREDICTION WITH PRE-FILTERING, AND METHOD AND APPARATUS FOR VIDEO DECODING USING INTER LAYER PREDICTION WITH POST-FILTERING

(75) Inventors: Byeong-doo CHOI, Siheung-si (KR); Dae-sung CHO, Seoul (KR); Seung-soo JEONG, Seoul (KR)

(73) Assignee: SAMSUNG ELECTRONICS CO., LTD., Suwon-si (KR)

(21) Appl. No.: 13/451,056

(22) Filed: Apr. 19, 2012

(30) Foreign Application Priority Data
Apr. 19, 2011 (KR) 10-2011-0036376

(51) Int. Cl. H04N 7/32; H04N 13/00

(52) U.S. Cl. 348/42; 375/E07.243

(57) ABSTRACT

Disclosed are a video encoding method and apparatus for encoding an image synthesized from at least one image, and a video decoding method and apparatus for decoding an image synthesized from at least one image. The video encoding method includes: generating a base layer bitstream by encoding first components of the at least one image; pre-filtering second components of the at least one image using a correlation between the first components and the second components; and generating an enhancement layer bitstream by encoding the pre-filtered second components with reference to the first components.

### CROSS-REFERENCE TO RELATED PATENT APPLICATION

This application claims priority from Korean Patent Application No. 10-2011-0036376, filed on Apr. 19, 2011 in the Korean Intellectual Property Office, the disclosure of which is incorporated herein in its entirety by reference.

### BACKGROUND

1. Field

Apparatuses and methods consistent with exemplary embodiments relate to video encoding and decoding using an inter-layer prediction.

2. Description of the Related Art

When a three-dimensional (3D) image of a left-view picture and a right-view picture is encoded through a video encoding system conforming to the H.264 Multiview Video Encoding (MVC) standard, a 3D image having half a resolution of an original image is encoded in a base layer, and data for complementing a resolution of the 3D image of the base layer is encoded in an enhancement layer.

In a video decoding system conforming to the H.264 MVC standard, a left-view picture component and a right-view picture component corresponding to half the resolutions of an original left-view picture and an original right-view picture may be recovered by decoding a base layer bitstream in a received bitstream. When a video decoding system conforming to the H.264 MVC standard receives an enhancement layer bitstream, a low-resolution left-view picture and a low-resolution right-view picture recovered in a base layer may be complemented using data obtained by decoding the received enhancement layer bitstream, and thus, a high-resolution left-view picture and a high-resolution right-view picture may be output.

### SUMMARY

Aspects of exemplary embodiments provide a method and apparatus for video encoding/decoding in which a pre-filtering operation or a post-filtering operation is performed considering the correlation between a base layer and an enhancement layer when a video of a synthesized image including at least one image is encoded/decoded based on inter-layer prediction between a base layer and an enhancement layer.

According to an aspect of an exemplary embodiment, there is provided a method of video encoding for encoding an image synthesized from at least one image, the method including: generating a base layer bitstream by encoding first components of the at least one image; pre-filtering second components of the at least one image using a correlation between the first components and the second components; and generating an enhancement layer bitstream by encoding the pre-filtered second components with reference to the first components.

The at least one image may include at least one multiview image captured from at least one different view, and a three-dimensional (3D) image composed of a left-view image and a right-view image.

According to an aspect of another exemplary embodiment, there is provided a method of video decoding for decoding an image synthesized from at least one image, the method including: restoring first components of the at least one image by decoding a received base layer bitstream; restoring second components of the at least one image by decoding a received enhancement layer bitstream and referring to the first components; and post-filtering the restored second components using a correlation between the first components and the second components.

According to an aspect of another exemplary embodiment, there is provided a video encoding device for encoding an image synthesized from at least one image, the device including: a layer component classifying unit configured to sample at least one image and classify sampled components into first components and second components; a base layer encoding unit configured to encode the first components of the at least one image and generate a base layer bitstream; a pre-filtering unit configured to perform pre-filtering to the second components of the at least one image for improving correlation with the first components; and an enhancement layer encoding unit configured to encode the pre-filtered second components by referring to the first components, and generate an enhancement layer bitstream.

According to an aspect of another exemplary embodiment, there is provided a video decoding device for decoding an image synthesized from at least one image, the device including: a base layer decoding unit configured to decode a received base layer bitstream and restore first components of the at least one image; an enhancement layer decoding unit configured to decode a received enhancement layer bitstream and restore second components of the at least one image referring to the first components; a post-filtering unit configured to perform post-filtering to the restored second components using a correlation between the first components and the second components; and an image restoring unit configured to restore the at least one image using the first components and the post-filtered second components.

According to an aspect of another exemplary embodiment, there is provided a computer-readable recording medium on which a computer executable program is recorded to implement a video encoding method according to an embodiment.

According to an aspect of another exemplary embodiment, there is provided a computer-readable recording medium on which a computer executable program is recorded to implement a video decoding method according to an embodiment.

According to an aspect of another exemplary embodiment, there is provided a method of video decoding for decoding an image synthesized from at least one image, the method including: restoring second components of the at least one image by decoding an enhancement layer bitstream and referring to first components, different from the second components, of the at least one image; and post-filtering the restored second components using a correlation between the first components and the second components.

### BRIEF DESCRIPTION OF THE DRAWINGS

The above and other features and advantages will become more apparent by describing in detail exemplary embodiments with reference to the attached drawings in which:

FIG. 1 is a block diagram illustrating a video encoding device according to an exemplary embodiment;

FIG. 2 is a block diagram illustrating a video decoding device according to an exemplary embodiment;

FIG. 3 is a block diagram illustrating a video encoding/decoding system conforming to the H.264 MVC standard;

FIG. 4 illustrates a scalable coding method for a three-dimensional image in a video encoding/decoding system according to an exemplary embodiment;

FIG. 5 is a block diagram illustrating a video encoding system for transmitting at least one full-resolution image according to an exemplary embodiment;

FIG. 6 is a block diagram illustrating a video decoding system for receiving at least one full-resolution image according to an exemplary embodiment;

FIG. 7 illustrates a pre-filtering operation according to an exemplary embodiment;

FIG. 8 illustrates a post-filtering operation according to an exemplary embodiment;

FIG. 9 illustrates a pre-filtering operation according to another exemplary embodiment;

FIG. 10 illustrates a post-filtering operation according to another exemplary embodiment;

FIG. 11 is a flowchart illustrating a video encoding method according to an exemplary embodiment; and

FIG. 12 is a flowchart illustrating a video decoding method according to an exemplary embodiment.

### DETAILED DESCRIPTION OF EXEMPLARY EMBODIMENTS

Exemplary embodiments will now be described more fully with reference to the accompanying drawings.

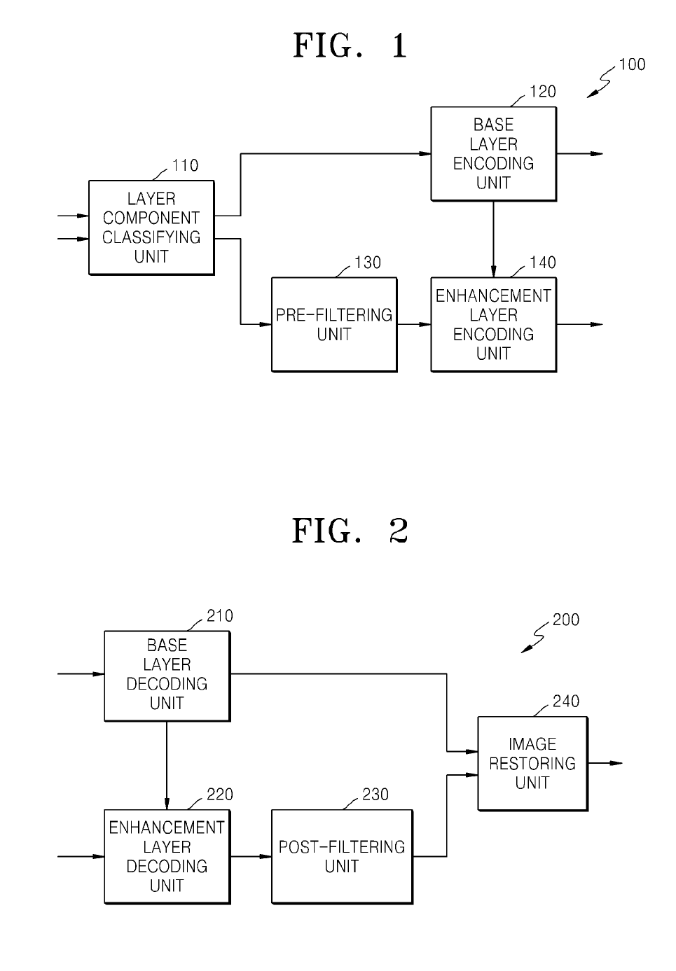

Hereinafter, a video encoding method and a video decoding method for receiving a composite image including at least one image and restoring at least one image to a full resolution, and a video encoding device and a video decoding device implementing the same, respectively, will be described with reference to FIGS. 1 to 12.

FIG. 1 is a block diagram illustrating a video encoding device 100 according to an exemplary embodiment.

The video encoding device 100 includes a layer component classifying unit 110, a base layer encoding unit 120, a pre-filtering unit 130, and an enhancement layer encoding unit 140.

The video encoding device 100 encodes a synthesis image in which image components extracted from multiple images are synthesized as one image. Multiple images may be synthesized as one picture or one frame. The video encoding device 100 according to an exemplary embodiment may encode a multiview image in which images captured from at least one different view are synthesized as one image. For instance, the video encoding device 100 according to an exemplary embodiment may encode a three-dimensional (3D) image composed of partial components extracted from a left-view image and partial components extracted from a right-view image.

Therefore, a 3D image including a left-view image and a right-view image may be encoded using a related art picture-based or frame-based video encoding system. However, a single 3D image includes image components corresponding to half the resolution of an original left-view image and image components corresponding to half the resolution of an original right-view image.

The layer component classifying unit 110 according to an exemplary embodiment samples at least one inputted image and classifies sampled elements into first components and second components. For instance, when the video encoding device 100 according to an exemplary embodiment encodes a 3D image composed of image components of a left-view image and image components of a right-view image, the layer component classifying unit 110 may sample the left-view image and the right-view image to extract odd numbered columns of the left-view image as the first components of the left-view image and to extract even numbered columns of the right-view image as the first components of the right-view image. That is, as the first components of the left-view image and the right-view image, a combination of odd numbered columns of the left-view image and even numbered columns of the right-view image may be sampled. In this case, the layer component classifying unit 110 may sample other components other than the first components of the left-view image and the right-view image, e.g., even numbered columns of the left-view image and odd columns of the right-view image, as the second components of the left-view image and the right-view image.

Similarly, the layer component classifying unit 110 may sample odd numbered rows of the left-view image and even numbered rows of the right-view image as the first components of the left-view image and the right-view image. As the second components of the left-view image and the right-view image, other components other than the first components of the left-view image and the right-view image, e.g., even numbered rows of the left-view image and odd numbered rows of the left-view image, may be sampled.

The layer component classifying unit 110 according to one or more exemplary embodiments may sample not only the above-described combination of odd numbered columns or rows of the left-view image and even numbered columns or rows of the right-view image but also a combination of odd numbered columns or rows of the left-view image and odd numbered columns or rows of the right-view image, a combination of even numbered columns or rows of the left-view image and odd numbered columns or rows of the right-view image, and a combination of even numbered columns or rows of the left-view image and even numbered columns or rows of the right-view image as the first components of the left-view image and the right-view image. Similarly, the second components of the left-view image and the right-view image may be combinations of image components other than the first components of the left-view image and the right-view image.

That is, the first components of the left-view image and the right-view image classified by the layer component classifying unit 110 according to an exemplary embodiment may include only image components corresponding to half the resolution of an original left-view image and image components corresponding to half the resolution of an original right-view image. Likewise, the second components of the left-view image and the right-view image, which are classified by the layer component classifying unit 110 according to an exemplary embodiment, may include only image components corresponding to half the resolution of an original left-view image and image components corresponding to half the resolution of an original right-view image.

The video encoding device 100 according to an exemplary embodiment may conform to a scalable coding method in which image components are classified into a base layer and an enhancement layer to be encoded.

The first components of at least one image classified by the layer component classifying unit 110 according to an exemplary embodiment may be input to the base layer encoding unit 120 to be encoded, and the second components of the image may be input to the pre-filtering unit 130 and encoded by the enhancement layer encoding unit 140. Therefore, the base layer encoding unit 120 and the enhancement layer encoding unit 140 may encode only image components corresponding to half the resolution of an original left-view image and image components corresponding to half the resolution of an original right-view image, respectively.

The base layer encoding unit 120 according to an exemplary embodiment encodes the first components of at least one image to generate a base layer bitstream.

The pre-filtering unit 130 according to an exemplary embodiment performs a pre-filtering operation on the second components of at least one image using a correlation between the first components and the second components.

The pre-filtering unit 130 according to an exemplary embodiment performs a pre-filtering operation on the second components to improve prediction efficiency between a base layer and an enhancement layer using high spatial correlation between the first components and the second components of one image. Therefore, for the pre-filtering unit 130 according to an exemplary embodiment, various filters for improving correlation between the first components and the second components may be used.

The video encoding device 100 according to an exemplary embodiment may encode information about filters used in the pre-filtering unit 130 and output the encoded information with an enhancement layer bitstream.

For instance, the pre-filtering unit 130 may perform phase shift filtering for compensating for a phase difference between the first components and the second components. Phase shift filtering according to an exemplary embodiment may include interpolation filtering on neighboring samples of the second components. That is, the phase shift filtering according to an exemplary embodiment may include interpolation filtering for neighboring odd numbered columns or rows, or neighboring even numbered columns or rows in the left-view image or the right-view image.

For instance, by the pre-filtering unit 130 performing filtering on the second components to improve correlation with the first components, the second components may be reconfigured as prediction values for the first components.

The enhancement layer encoding unit 140 according to an exemplary embodiment encodes the pre-filtered second components by referring to the first components to generate an enhancement layer bitstream. The enhancement layer encoding unit 140 according to an exemplary embodiment may predict the pre-filtered second components by referring to the first components to encode the pre-filtered second components.

The video encoding device 100 according to an exemplary embodiment may output a base layer bitstream generated by the base layer encoding unit 120 and an enhancement layer bitstream generated by the enhancement layer encoding unit 140. A base layer bitstream obtained by encoding image components corresponding to half the resolution of at least one original image, and an enhancement layer bitstream obtained by encoding image components corresponding to the other half resolution of the original image may be transmitted.

Also, because a predictive encoding operation referring to the first components is performed on the second components of which correlation with the first components has been improved through pre-filtering, a transmission rate may be improved. Therefore, as transmission efficiency of an enhancement layer bitstream is improved, an overall efficiency of transmission conforming to a scalable coding method of the video encoding device 100 according to an exemplary embodiment may be improved.

FIG. 2 is a block diagram illustrating a video decoding device 200 according to an exemplary embodiment.

The video decoding device 200 includes a base layer decoding unit 210, an enhancement layer decoding unit 220, a post-filtering unit 230, and an image restoring unit 240.

The video decoding device 200 according to an exemplary embodiment receives a bitstream in which a synthesis image of image components extracted from multiple images is encoded. The video decoding device 200 according to an exemplary embodiment may receive a bitstream in which a multiview image composed of components of images captured from at least one view and a 3D image, in which partial components of a left-view image and a right-view image are arranged, are encoded.

The video decoding device 200 according to an exemplary embodiment may conform to a scalable decoding method in which classification into a base layer and an enhancement layer is performed for decoding. Therefore, the video decoding device 200 according to an exemplary embodiment may parse a received bitstream into a base layer bitstream and an enhancement layer bitstream. The base layer bitstream may be transferred to the base layer decoding unit 210 to be decoded, and the enhancement layer bitstream may be transferred to the enhancement layer decoding unit 220 to be decoded.

The base layer decoding unit 210 according to an exemplary embodiment decodes a received base layer bitstream to restore the first components of at least one image. The enhancement layer decoding unit 220 according to an exemplary embodiment decodes a received enhancement layer bitstream, and restores the second components of at least one image referring to the first components.

The enhancement layer decoding unit 220 according to an exemplary embodiment may restore residual components of the first and second components from an enhancement layer bitstream. The enhancement layer decoding unit 220 according to an exemplary embodiment may restore the second components by performing an inter-layer compensation on the residual components of the first and second components by referring to the first components decoded by the base layer decoding unit 210.

For instance, when the video decoding device 200 according to an exemplary embodiment decodes a 3D image composed of a left-view image and a right-view image, the base layer decoding unit 210 according to an exemplary embodiment may decode a base layer bitstream for restoring odd numbered columns or rows of the left-view image as first components of the left-view image and for restoring even numbered columns or rows of the right-view image as first components of the right-view image. That is, as the first components of the left-view image and the right-view image, a combination of odd numbered columns or rows of the left-view image and even numbered columns or rows of the right-view image may be restored. In this case, the enhancement layer decoding unit 220 according to an exemplary embodiment may decode the other components other than the first components of the left-view image and the right-view image as the second components of the left-view image and the right-view image.

The base layer decoding unit 210 according to an exemplary embodiment may decode not only the above-described combination of odd numbered columns or rows of the left-view image and even numbered columns or rows of the right-view image, but also a combination of odd numbered columns or rows of the left-view image and odd numbered columns or rows of the right-view image, a combination of even numbered columns or rows of the left-view image and odd numbered columns or rows of the right-view image, and a combination of even numbered columns or rows of the left-view image and even numbered columns or rows of the right-view image as the first components of the left-view image and the right-view image. Similarly, the enhancement layer decoding unit 220 according to an exemplary embodiment may decode the other image components other than the first components of the left-view image and the right-view image as the second components of the left-view image and the right-view image.

That is, the first components of the left-view image and the right-view image decoded by the base layer decoding unit 210 according to an exemplary embodiment may include only image components corresponding to half the resolution of an original left-view image and image components corresponding to half the resolution of an original right-view image.

The post-filtering unit 230 according to an exemplary embodiment performs a post-filtering operation on the second components restored by the enhancement layer decoding unit 220 using the correlation with the first components.

For the post-filtering unit 230 according to an exemplary embodiment, various filters for improving correlation between the first and second components may be used. Through a filtering operation of the post-filtering unit 230, prediction efficiency between a base layer and an enhancement layer may be improved by virtue of high spatial correlation between the first and second components. The video decoding device 200 according to an exemplary embodiment may extract information about a filter used in the post-filtering unit 230 from a received bitstream, and the post-filtering unit 230 may configure a post-filter using the extracted filter information.

For the post-filtering unit 230 according to an exemplary embodiment, as an example of various filters for improving correlation between the first and second components, a phase shift filter for compensating for a phase difference between the first and second components may be used. Phase shift filtering of the post-filtering unit 230 according to an exemplary embodiment may include inverse interpolation filtering for neighboring samples of the second components restored by the enhancement layer decoding unit 220. That is, the phase shift filtering of the post-filtering unit 230 according to an exemplary embodiment may include inverse interpolation filtering for neighboring odd numbered columns or rows or neighboring even numbered columns or rows in the left-view image or the right-view image.

The image restoring unit 240 according to an exemplary embodiment restores at least one image using the first components decoded by the base layer decoding unit 210 and the second components post-filtered by the post-filtering unit 230.

For instance, when the video decoding device 200 receives a bitstream in which a 3D image of a left-view image and a right-view image is encoded, the first components of the left-view image and the right-view image are restored by the base layer decoding unit 210, and the other components other than the first components of the left-view image and the right-view image are restored by the post-filtering unit 230 through a post-filtering operation. Thus, the image restoring unit 240 may restore the left-view image and the right-view image.

Therefore, according to the video decoding unit 200 according to an exemplary embodiment, a base layer bitstream in which image components corresponding to half the resolution of an original image of at least one image are encoded is decoded, and an enhancement layer bitstream in which the other image components are encoded is decoded to be supplementally used for restoring the at least one image. Therefore, a full-resolution original image of at least one image may be restored.

Therefore, according to the video encoding device 100 and the video decoding device 200 according to one or more exemplary embodiments, when a 3D image composed of only image components corresponding to half the resolutions of a left-view image and a right-view image is encoded/decoded as a base layer, and image components of the other half resolutions are encoded/decoded as an enhancement layer, inter-layer prediction efficiency of the enhancement layer is improved through pre-filtering and post-filtering operations using spatial correlation between the base layer and the enhancement layer. Thus, encoding/decoding efficiency of a whole 3D image may be improved.

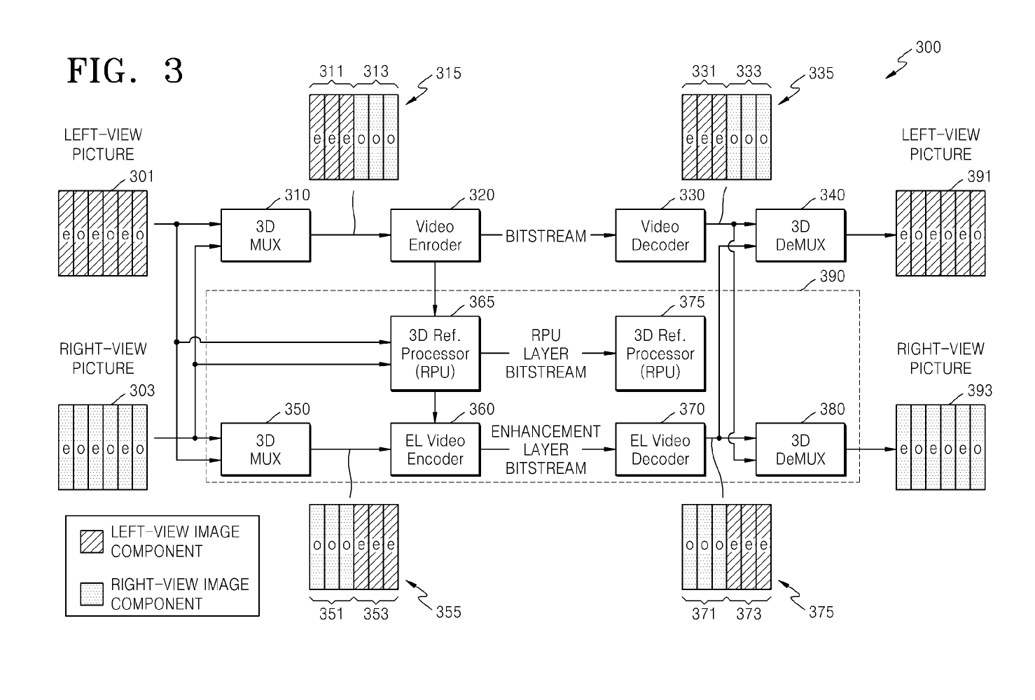

FIG. 3 is a block diagram illustrating a video encoding/decoding system 300 conforming to the H.264 Multiview Video Coding (MVC) standard.

The video encoding/decoding system 300 conforming to the H.264 MVC standard encodes/decodes a 3D image having half a resolution of an original image in a base layer, and encodes/decodes data for supplementing the 3D image of the base layer, which has a resolution of an original image in an enhancement layer.

For instance, for compatibility with a frame-based two-dimensional (2D) video encoding/decoding system, a left-view picture 301 and a right-view picture 303 of a 3D video may be configured as a 3D picture using a side-by-side method. A first 3D multiplexer 310 configures a base layer 3D picture 315 in which even numbered columns 311 of the left-view picture 301 and odd numbered columns 313 of the right-view picture 303 are arranged. The base layer 3D picture 315 is encoded by a base layer video encoder 320 and is transmitted in the form of a bitstream.

A base layer video decoder 330 decodes a received bitstream to restore a base layer 3D picture 335. In the base layer 3D picture 335, a left region 331 corresponds to half the resolution of the original left-view picture 301 and a right region 333 corresponds to half the resolution of the original right-view picture 303. Therefore, the base layer video decoder 330 restores an image having half the resolutions of the original left-view picture 301 and the original right-view picture 303.

However, the video encoding/decoding system 300 conforming to the H.264 MVC standard performs an encoding/decoding operation for each of a base layer and an enhancement layer according to a scalable coding method. A second 3D multiplexer 350 configures an enhancement layer 3D picture 355 in which odd numbered columns 351 of the left-view picture 301 and even numbered columns 353 of the right-view picture 303 are arranged. The enhancement layer 3D picture 355 is encoded by an enhancement layer video encoder 360 so that an enhancement layer bitstream is transmitted.

An enhancement layer video decoder 370 decodes a received enhancement layer bitstream to restore an enhancement layer 3D picture 375. In a left region 371 of the enhancement layer 3D picture 375, the other image having half the resolution of the original left-view picture 301 may be restored, and in a right region 373 of the enhancement layer 3D picture 375, the other image having half the resolution of the original right-view picture 303 may be restored.

A first 3D demultiplexer 340 arranges the left region 331 of the base layer 3D picture 335 restored by the base layer video decoder 330 as even numbered columns of a restored left-view picture 391, and arranges the left region 371 of the enhancement layer 3D picture 375 as odd numbered columns of the restored left-view picture 391. Accordingly, the restored left-view picture 391 is outputted having the same full resolution as the original left-view picture 301.

Also, a second 3D demultiplexer 380 arranges the right region 373 of the enhancement layer 3D picture 375 restored by the enhancement layer video decoder 370 as even numbered columns of a restored right-view picture 393, and arranges the right region 333 of the base layer 3D picture 335 as odd numbered columns of the restored right-view picture 393. Therefore, the restored right-view picture 393 may be output having the same full resolution as the original right-view picture 303.

Therefore, according to the video encoding/decoding system 300 conforming to the H.264 MVC standard, if all image bitstreams transmitted through a base layer and an enhancement layer are decoded, a full-resolution left-view image and a full-resolution right view image having the same resolutions as an original left-view image and an original right view image may be restored.

For the video encoding/decoding system 300 conforming to the H.264 MVC standard to perform prediction between a base layer and an enhancement layer, 3D reference processor units (RPUs) 365 and 375 may be included. The 3D RPU 365 may refer to not only a base layer 3D image, but also inputted left-view and right-view pictures for inter-layer prediction at an encoding stage. The 3D RPU 365 may transmit a bitstream in which information of inter-layer prediction is encoded at an encoding stage, and the 3D RPU 375 of a decoding stage may receive the bitstream of inter-layer prediction so that inter-layer prediction and compensation of the enhancement layer video decoder 370 may be supported.

Therefore, for the 3D RPUs 365 and 375 to be included between the base layer video encoder 320 and the enhancement layer video encoder 360 and between the base layer video decoder 330 and the enhancement layer video decoder 370, respectively, a core of an enhancement layer encoding/decoding module 390 of the video encoding/decoding system 300 may be structurally changed.

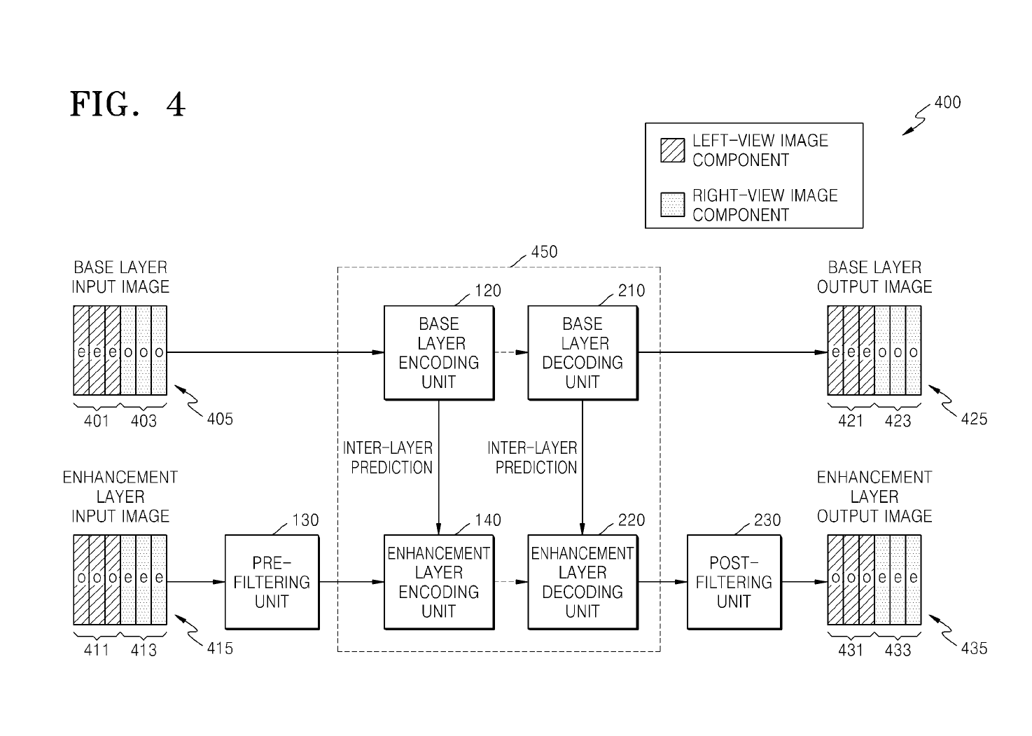

FIG. 4 illustrates a scalable coding method for a 3D image in a video encoding/decoding system 400 according to an exemplary embodiment.

The video encoding/decoding system 400 according to an exemplary embodiment includes the video encoding system 100 according to an exemplary embodiment and the video decoding system 200 according to an exemplary embodiment. The video encoding/decoding system 400 according to an exemplary embodiment includes a pre-filtering unit 130 for enhancement layer encoding, and a post-filtering unit 230 for enhancement layer decoding.

The video encoding/decoding system 400 conforming to the H.264 MVC standard may encode/decode a 3D image having half a resolution of an original image in a base layer, and may encode/decode data for supplementing the 3D image of the base layer, which has a resolution of an original image in an enhancement layer.

For encoding/decoding a 3D image in which a left-view image and a right-view image are synthesized according to a side-by-side method in the video encoding/decoding system 400 according to an exemplary embodiment, a base layer input image 405 composed of even numbered columns 401 of the left-view image and odd numbered columns 403 of the right-view image may be encoded by a base layer encoding unit 120 to transmit a base layer bitstream.

A base layer decoding unit 210 may decode a received base layer bitstream to restore a base layer output image 425. A left region 421 and a right region 423 of the base layer output image 425 correspond to half the resolution of an original left-view image and half the resolution of an original right-view image, respectively, and thus, the base layer output image 425 has half the resolution of the original left-view image and the original right-view image.

Also, the video encoding/decoding system 400 according to an exemplary embodiment may perform an encoding/decoding operation according to a scalable coding method in an enhancement layer. Before performing an enhancement layer encoding operation on an enhancement layer input image 415 in which odd numbered columns 411 of a left-view image and even numbered columns 413 of a right-view image are arranged, the pre-filtering unit 130 may perform a filtering operation on left-view image components and right-view image components composing the enhancement layer input image 415 to improve inter-layer prediction performance. A forward conversion and an inverse conversion may be possible for a filtering operation of the pre-filtering unit 130.

The enhancement layer input image 415 may be encoded by an enhancement layer encoding unit 140 after being filtered by the pre-filtering unit 130. The enhancement layer encoding unit 140 predicts filtered data of the enhancement layer input image 415 by referring to the base layer input image 405 encoded by the base layer encoding unit 120 so that an enhancement layer bitstream may be output. The enhancement layer encoding unit 140 may encode prediction information, for example, residual components of filtered data of the enhancement layer input image 415 in comparison with the base layer input image 405.

An enhancement layer decoding unit 220 may decode a received enhancement layer bitstream to decode an enhancement layer output image 435. The enhancement layer decoding unit 220 according to an exemplary embodiment may perform a compensation operation by referring to the base layer output image 425 restored by the base layer decoding unit 210 so that an initial image of the enhancement layer output image 435 may be restored.

After the initial image of the enhancement layer output image 435, which is restored by the enhancement layer decoding unit 220, is filtered through the post-filtering unit 230, the enhancement layer output image 435 may be restored. Because a filter used in the post-filtering unit 230 performs an inverse conversion in comparison with a filter used in the pre-filtering unit 130, left-view image components and right-view image components composing the enhancement layer output image 435 may be correctly restored.

Therefore, through the enhancement layer decoding unit 220 and the post-filtering unit 230, the enhancement layer output image 435 may be output. A left region 431 and a right region 433 of the restored enhancement layer output image 435 correspond to half the resolution of an original left-view image and half the resolution of an original right-view image, respectively. Thus, the enhancement layer output image 435 has half the resolution of the original left-view image and the original right-view image. Therefore, because the enhancement layer output image 435 is restored, the other image components not included in the base layer output image 425 may be restored.

According to the video encoding/decoding system 400 according to an exemplary embodiment, if all image bitstreams transmitted through a base layer and an enhancement layer are decoded, a full-resolution left-view image and a full-resolution right view image may be restored.

The pre-filtering unit 130 according to an exemplary embodiment may improve the performance of inter-layer prediction of scalable encoding through a filtering operation, which previously adjusts enhancement layer 3D image components so that the enhancement layer 3D image components become similar to base layer 3D image components, using high correlation of the base layer 3D image components and the enhancement layer 3D image components. The post-filtering unit 230 according to an exemplary embodiment may perform an inverse conversion filtering operation in comparison with a filtering operation of the pre-filtering unit 130 to reconfigure image components of the enhancement layer output image and restore the enhancement layer output image. Therefore, without a structural change to a scalable encoding/decoding core 450, inter-layer prediction may be efficiently performed.

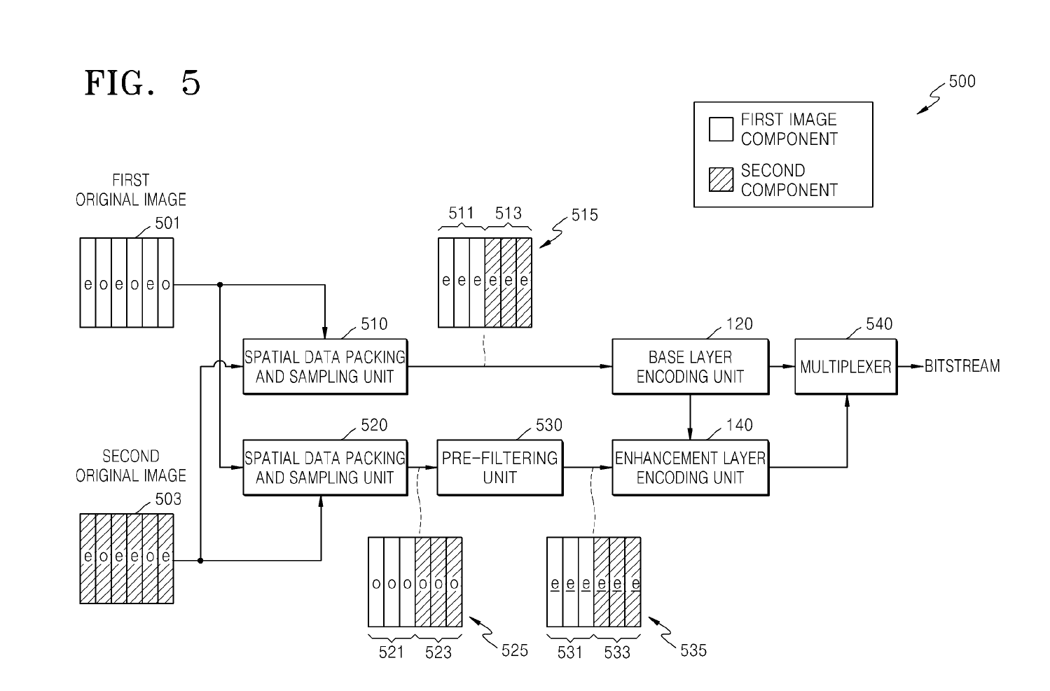

FIG. 5 is a block diagram illustrating a video encoding device 500 for transmitting at least one full-resolution image according to an exemplary embodiment.

In the video encoding device 500 according to an exemplary embodiment, a 3D image having half the resolution of a first original image 501 and a second original image 503 may be encoded in a base layer, and an image having other image components of the first and second original images 501 and 503 may be encoded in an enhancement layer for supplementing the 3D image having the half-resolution.

A first spatial data packing and sampling unit 510 and a second spatial data packing and sampling unit 520 are examples of the layer component classifying unit 110, and sample every other column of spatial image components of the first and second original images 501 and 503.

Therefore, the first spatial data packing and sampling unit 510 may sample and pack even numbered columns of the first original image 501 to arrange them in a left region 511 of a base layer input image 515, and may sample and pack even numbered columns of the second original image 503 to arrange them in a right region 513 of the base layer input image 515.

The second spatial data packing and sampling unit 520 may sample the other image components not sampled by the first spatial data packing and sampling unit 510 as supplementary data of the base layer input image 515. Therefore, the second spatial data packing and sampling unit 520 may sample and pack odd numbered columns of the first original image 501 to arrange the odd numbered columns of the first original image 501 in a left region 521 of an enhancement layer input image 525, and may sample and pack odd numbered columns of the second original image 503 to arrange the odd numbered columns of the second original image 502 in a right region 523 of the enhancement layer input image 523.

A pre-filtering unit 530 may perform a filtering operation for improving inter-layer prediction on the enhancement layer input image 525 before the enhancement layer input image 525 is encoded into a bitstream by an enhancement layer encoding unit 140. In one of the first original image 501 and the second original image 503, image components of even numbered columns are spatially adjacent to image components of odd numbered columns, and thus, spatial correlation is high and there is a phase difference. Therefore, spatial correlation between the base layer input image 515 composed of image components of even numbered columns of an original image and the enhancement layer input image 525 composed of image components of odd numbered columns of the original image is high.

The pre-filtering unit 530 may perform phase shift filtering for compensating for a phase difference using the spatial characteristics of the base layer input image 515 and the enhancement layer input image 525. That is, the pre-filtering unit 530 may output an enhancement layer filtered image 535 composed of prediction values in comparison with the base layer input image 515 by performing phase shift filtering on the enhancement layer input image 525 for compensating for a phase difference with the base layer input image 515.

In detail, the pre-filtering unit 530 may generate prediction values of odd numbered columns in comparison with even numbered columns of the first original image 501 arranged in the left region 511 of the base layer input image 515 by performing phase shift filtering on odd numbered columns of the first original image 501 arranged in the left region 521 of the enhancement layer input image 525.

Also, the pre-filtering unit 530 may generate prediction values of odd numbered columns in comparison with even numbered columns of the second original image 503 arranged in the right region 513 of the base layer input image 515 by performing phase shift filtering on odd numbered columns of the second original image 503 arranged in the right region 523 of the enhancement layer input image 525.

Therefore, result data generated by the pre-filtering unit 530 may be prediction values of odd numbered columns in comparison with even numbered columns of the first original image 501 composing the enhancement layer input image 525, and prediction values of odd numbered columns in comparison with even numbered columns of the second original image 503 composing the enhancement layer input image 525. The prediction values from odd numbered columns in comparison with even numbered columns of the first original image 501 and the prediction values of odd numbered columns in comparison with even numbered columns of the second original image 503 may respectively compose a left region 531 and a right region 533 of the enhancement layer filtered image 535.

Because spatial correlation between the enhancement layer filtered image 535 and the base layer input image 515 is more improved through the pre-filtering unit 530 according to an exemplary embodiment, residual components due to inter-layer prediction are reduced, and thus, a transmission rate is increased. Therefore, inter-layer prediction performance may be improved.

The base layer input image 515 may be encoded by the base layer encoding unit 120, and the enhancement layer filtered image 535 may be encoded by the enhancement layer encoding unit 140. The enhancement layer encoding unit 140 may predict the enhancement layer filtered image 535 by referring to the base layer input image 515. A multiplexer 540 may transmit an output bitstream by multiplexing a base layer bitstream generated by the base layer encoding unit 120 and an enhancement layer bitstream generated by the enhancement layer encoding unit 140.

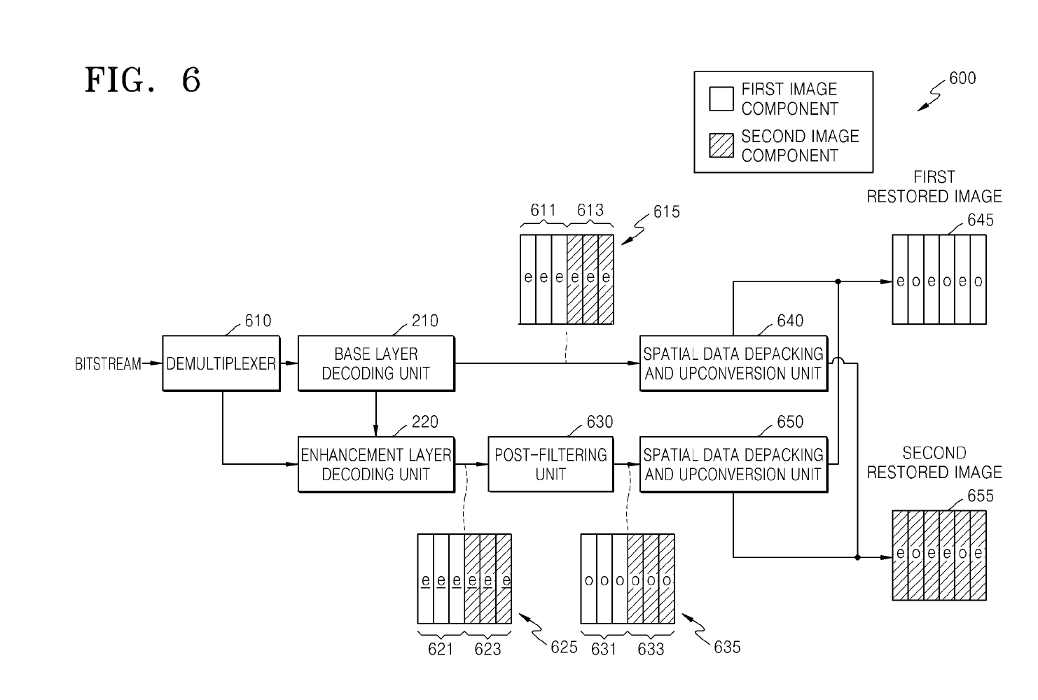

FIG. 6 is a block diagram illustrating a video decoding device 600 for receiving at least one full-resolution image according to an exemplary embodiment.

Through the video decoding device 600 according to an exemplary embodiment, a 3D image having half the resolution of the first original image 501 and the second original image 503 may be decoded in a base layer, and a first restored image 645 and a second restored image 655 having the same resolutions as the first and second original images 501 and 503 may be restored in an enhancement layer by decoding image components for supplementing the 3D image having a half-resolution.

A demultiplexer 610 may parse a received bitstream to transfer a base layer bitstream to the base layer decoding unit 210, and transfer an enhancement layer bitstream to the enhancement layer decoding unit 220.

The base layer decoding unit 210 may decode a received base layer bitstream to restore a base layer output image 615. Because a left region 611 and a right region 613 of the base layer output image 615 correspond to even numbered columns of the first original image 501 and even numbered columns of the second original image 503, respectively, the base layer output image 615 has half the resolution of the first original image 501 and the second original image 503.

The enhancement layer decoding unit 220 may decode a received enhancement layer bitstream to restore an enhancement layer restored image 625. The enhancement layer decoding unit 220 according to an exemplary embodiment may perform a compensation operation by referring to the base layer output image 615 restored by the base layer decoding unit 210 so that the enhancement layer restored image 625 may be restored. The enhancement layer restored image 625 has half the resolution of the first original image 501 and the second original image 503.

After the enhancement layer restored image 625 restored by the enhancement layer decoding unit 220 is filtered through a post-filtering unit 630, an enhancement layer output image 635 may be restored. Because a filter used in the post-filtering unit 630 performs an inverse conversion in comparison with a filter used in the pre-filtering unit 530, image components corresponding to odd numbered columns of the first original image 501 and odd numbered columns of the second original image 503 composing the enhancement layer restored image 625 may be correctly restored.

That is, the post-filtering unit 630 may output the enhancement layer output image 635 by performing phase shift filtering on the enhancement layer restored image 625 for compensating for a phase difference with the base layer output image 615.

In detail, the post-filtering unit 630 may restore odd numbered columns of the first original image 501 by performing an inverse conversion filtering operation, which is a reversed operation of a pre-filtering operation, on prediction values of odd numbered columns in comparison with even numbered columns of the first original image 501 arranged in a left region 621 of the enhancement layer restored image 625.

Also, the post-filtering unit 630 may restore odd numbered columns of the second original image 503 by performing an inverse conversion filtering operation, which is a reversed operation of a pre-filtering operation, on prediction values of odd numbered columns in comparison with even numbered columns of the second original image 503 arranged in a right region 623 of the enhancement layer restored image 625.

The left region 631 and the right region 633 of the enhancement layer output image 635 restored by the post-filtering unit 630 may correspond to image components of odd numbered columns of the first original image 501 and odd numbered columns of the second original image 503. The enhancement layer output image 635 restored also has half the resolution of the first original image 501 and the second original image 503.

A first spatial data de-packing and up-conversion unit 640 and a second spatial data de-packing and up-conversion unit 650 are examples of the image restoring unit 240, and may spatially reconfigure the base layer output image 615 and the enhancement layer output image 635 to output the first restored image 645 and the second restored image 655.

In detail, the first spatial data de-packing and up-conversion unit 640 may arrange image components of the left region 611 of the base layer output image 615 on even numbered columns of the first restored image 645, and may arrange image components of the right region 613 of the base layer output image 615 on even numbered columns of the second restored image 655. The second spatial data de-packing and up-conversion unit 650 may arrange image components of the left region 631 of the enhancement layer output image 635 on odd numbered columns of the first restored image 645, and may arrange image components of the right region 633 of the enhancement layer output image 635 on odd numbered columns of the second restored image 655.

Accordingly, the first spatial data de-packing and up-conversion unit 640 and the second spatial data de-packing and up-conversion unit 650 may output the first restored image 645 and the second restored image 655 having the same resolutions as the first original image 501 and the second original image 503, respectively, by reconfiguring the base layer output image 615 and the enhancement layer output image 635 having half the resolution of the first original image 501 and the second original image 503.

Therefore, according to the video decoding system 600 according to an exemplary embodiment, if all bitstreams transmitted through a base layer and an enhancement layer are decoded, the full-resolution first and second restored images 645 and 655 may be restored.

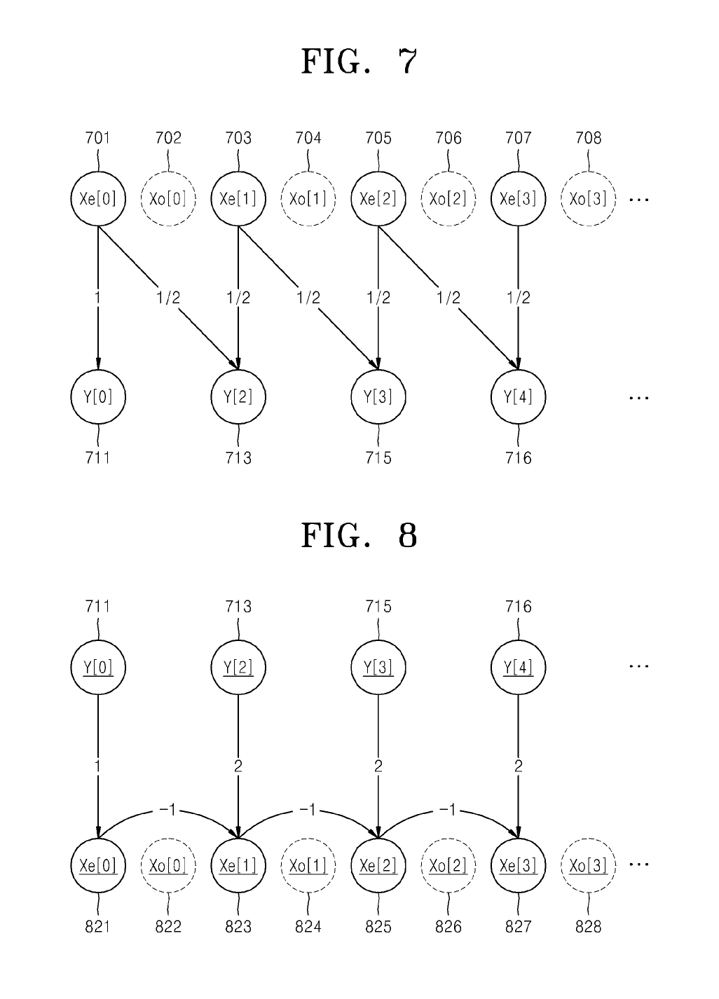

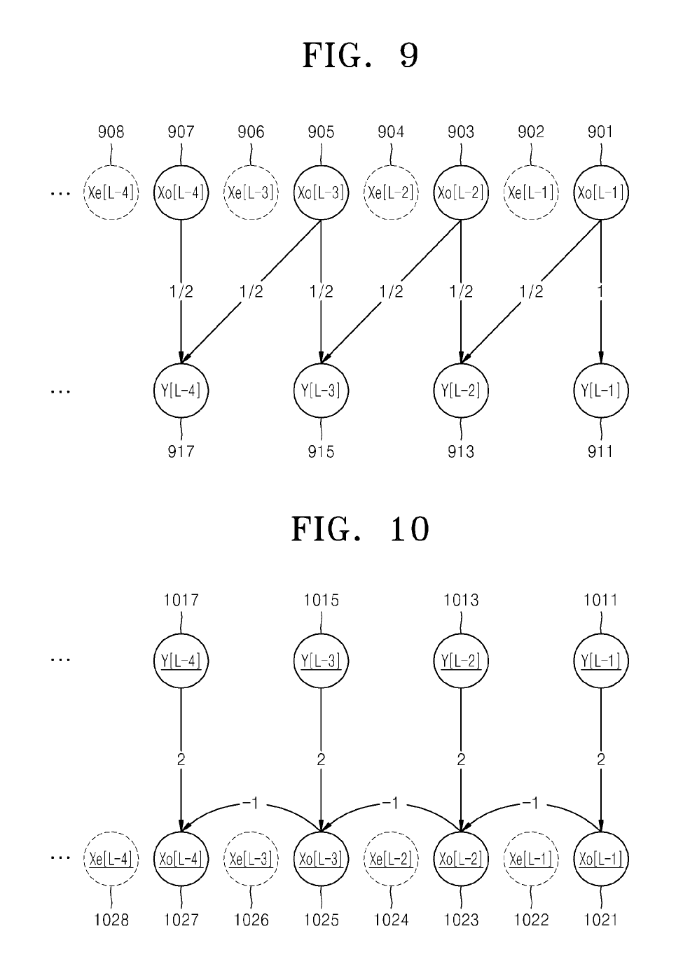

Hereinafter, detailed operations of the pre-filtering unit 530 will be described with reference to FIGS. 7 and 9, and detailed operations of the post-filtering unit 630 will be described with reference to FIGS. 8 and 10. FIGS. 7 and 8 illustrate that pixels of an enhancement layer image correspond to even numbered pixels of a first original image or a second original image, and FIGS. 9 and 10 illustrate that the pixels correspond to odd numbered pixels of the first original image or the second original image. Because principles of the operations of the pre-filtering unit 530 and principles of the operations of the post-filtering unit 630 are common for a first original image and a second original image, “a first original image or a second original image” is referred to as “an original image” for convenience.

FIG. 7 illustrates a pre-filtering operation according to an exemplary embodiment.

Pixels 701 to 708 are samples of an original image, and pixels 711, 713, 715, and 717 are samples of an enhancement layer input image pre-filtered by the pre-filtering unit 530 according to an exemplary embodiment.

Among the pixels 701 to 708 of the original image, odd numbered pixels 702, 704, 706, and 708 as first components of the original image may compose a base layer input image, and even numbered pixels 701, 703, 705, and 707 as second components of the original image may compose an enhancement layer input image.

The pre-filtering unit 530 may perform an interpolation filtering operation as a phase shift filtering operation for compensating for a phase difference between the odd numbered pixels of the original image composing the base layer input image and the even numbered pixels of the original image composing the enhancement layer input image. For instance, the pre-filtering unit 530 may output prediction values of odd numbered pixels located between even numbered pixels in the original image through an interpolation filtering operation on even numbered pixels of the original image in the enhancement layer input image. That is, through an interpolation filtering operation on continuous pixels of the enhancement layer input image, prediction values of pixels of the base layer input image may be output.

In detail, through an interpolation filtering operation on continuous pixels 701 and 703 among the pixels 701, 703, 705, and 707 composing the enhancement layer input image, a prediction value of the pixel 702, which is an odd numbered pixel located between the even numbered pixels 701 and 703 in the original image and composes the base layer input image, may be output. Similarly, through an interpolation filtering operation on continuous pixels 703 and 705 of the enhancement layer input image, a prediction value of the pixel 704 of the base layer input image may be output. Furthermore, through an interpolation filtering operation on continuous pixels 705 and 707 of the enhancement layer input image, a prediction value of the pixel 706 of the base layer input image may be output.

For instance, the pre-filtering unit 530 according to an exemplary embodiment may perform an interpolation filtering operation adding the same weight to continuous pixels of the enhancement layer input image. When n is a positive integer, each pixel value of the even numbered pixels 701, 703, 705, and 707 of the original image composing the enhancement layer input image is Xe[n], each pixel value of the odd numbered pixels 702, 704, 706, and 708 of the original image composing the base layer input image is Xo[n], and each pixel value obtained by pre-filtering the enhancement layer input image is Y[n], a filtering operation of the pre-filtering unit 530 according to an exemplary embodiment may conform to the following Equation 1:

Y[0]=Xe[0]

Y[1]=(Xe[0]+Xe[1]+1)/2≈Xo[0]

Y[2]=(Xe[1]+Xe[2]+1)/2=Xo[1]

Y[3]=(Xe[2]+Xe[3]+1)/2=Xo[2] [Equation 1]

According to Equation 1, the pre-filtering unit 530 according to an exemplary embodiment may perform a weighted sum filtering operation adding a weight of ½ to each of the continuous pixels of the enhancement layer input image for outputting prediction values for the base layer input image. Therefore, when an encoding operation is performed through inter-layer prediction between the base layer input image and the enhancement layer input image, prediction encoding between prediction values of the base layer input image generated through a pre-filtering operation of the enhancement layer input image and the base layer input image is performed. Thus, prediction performance may be improved, and a transmission rate may also be improved.

FIG. 8 illustrates a post-filtering operation according to an exemplary embodiment.

Pixels 811, 813, 815, and 817 are samples of an enhancement layer stored image restored by the enhancement layer decoding unit 220. The post-filtering unit 630 according to an exemplary embodiment may output pixels 821, 823, 825, and 827 composing an enhancement layer output image by performing a phase shift filtering operation on the pixels 811, 813, 815, and 817 of the enhancement layer stored image.

Pixels 821 to 828 are samples composing a first restored image or a second restored image. Because a principle of a post-filtering operation is the same for a first restored image and a second restored image, “a first restored image or a second restored image” is referred to as “a restored image” for convenience.

The post-filtering unit 630 may perform an inverse interpolation filtering operation as an inverse conversion of the pre-filtering unit 530 which performs a phase shift filtering operation for compensating for a phase difference between the odd numbered pixels of the original image composing the base layer input image and the even numbered pixels of the original image composing the enhancement layer input image. For instance, the post-filtering unit 630 may restore the pixels 821, 823, 825, and 827 of the enhancement layer output image using the pixels 811, 813, 815, and 817 of the enhancement layer restored image which are prediction values of pixels of the base layer input image.

For instance, when the pre-filtering unit 530 according to an exemplary embodiment performs an interpolation filtering operation adding the same weight to continuous pixels of the enhancement layer input image, an inverse interpolation filtering operation of the post-filtering unit 630 may conform to the following Equation 2. Each pixel value of the pixels 811, 813, 815, and 817 composing the enhancement layer restored image encoded from an enhancement layer bitstream is expressed as ‘Y[n]’, and each pixel value of the pixels 821, 823, 825, and 827 of the enhancement layer output image outputted through a post-filtering operation on the enhancement layer restored image is expressed as ‘Xe[n]’, where n is a positive integer.

Xe[0]=Y[0]

Xe[1]=2*Y[1]−Xe[0]

[2]=2*Y[2]−Xe[1]

[3]=2*Y[3]−Xe[2] [Equation 2]

When each pixel value of the pixels 822, 824, 826, and 828 of the base layer output image decoded from a base layer bitstream is expressed as ‘Xo[n]’, the pixel value may have a value similar to the pixel value Y[n] of the enhancement layer restored image.

Therefore, through the post-filtering unit 630, the pixels 821, 823, 825, and 827 of the enhancement layer output image corresponding to even numbered pixels of a restored image may be correctly restored.

The base layer decoding unit 210 may restore the pixels 822, 824, 826, and 828 which are samples of the base layer output image corresponding to odd numbered pixels of a restored image.

Therefore, the pixels 821, 823, 825, and 827 of the enhancement layer output image compose even numbered pixels of one of a first restored image and a second restored image, and the pixels 822, 824, 826, and 828 of the base layer output image compose odd numbered pixels of the restored image for outputting the restored image.

FIG. 9 illustrates a pre-filtering operation according to another exemplary embodiment.

Pixels 901 to 908 are samples of an original image, and pixels 911, 913, 915, and 917 are samples of an enhancement layer input image pre-filtered by a pre-filtering unit 530 according to another exemplary embodiment.

Even numbered pixels 902, 904, 906, and 908 of an original image as first components of the original image may compose a base layer input image, and odd numbered pixels 901, 903, 905, and 907 as second components of the original image may compose an enhancement layer input image.

The pre-filtering unit 530 according to an exemplary embodiment may perform an interpolation filtering operation as a phase shift filtering operation for compensating for a phase difference between the even numbered pixels of the original image composing the base layer input image and the odd numbered pixels of the original image composing the enhancement layer input image. For instance, the pre-filtering unit 530 may output prediction values of even numbered pixels located between odd numbered pixels in the original image, i.e., prediction values of pixels of the base layer input image, through an interpolation filtering operation performed to continuous pixels of the enhancement layer input image.

For instance, the pre-filtering unit 530 according to an exemplary embodiment may perform an interpolation filtering operation adding the same weight to continuous pixels of the enhancement layer input image. When n is 0 or a positive integer smaller than or equal to L, each pixel value of the odd numbered pixels 901, 903, 905, and 907 of the original image composing the enhancement layer input image is Xo[n], each pixel value of the even numbered pixels 902, 904, 906, and 908 of the original image composing the base layer input image is Xe[n], and a pixel value obtained by pre-filtering the enhancement layer input image is Y[n], a filtering operation of the pre-filtering unit 530 according to an exemplary embodiment may conform to the following Equation 3:

Y[L−1]=Xo[L−1]

Y[L−2]=(Xo[L−1]+Xo[L−2]+1)/2≈Xe[L−1]

Y[L−3]=(Xo[L−2]+Xo[L−1]+1)/2≈Xe[L−2]

Y[L−4]=(Xo[L−3]+Xo[L−2]+1)/2≈Xe[L−3] [Equation 3]

According to Equation 3, the pre-filtering unit 530 according to an exemplary embodiment may perform a weighted sum filtering operation adding a weight of ½ to each of the continuous pixels of the enhancement layer input image for outputting prediction values for the base layer input image. Therefore, because prediction encoding between prediction values of the base layer input image generated through a pre-filtering operation on the enhancement layer input image and the base layer input image is performed, the performance of prediction between a base layer and an enhancement layer may be improved.

FIG. 10 illustrates a post-filtering operation according to another exemplary embodiment.

Pixels 1011, 1013, 1015, and 1017 are samples of an enhancement layer stored image restored by the enhancement layer decoding unit 220. The post-filtering unit 630 according to an exemplary embodiment may output pixels 1021, 1023, 1025, and 1027 composing an enhancement layer output image by performing a phase shift filtering operation on the pixels 1011, 1013, 1015, and 1017 of the enhancement layer stored image. Pixels 1021 to 1028 are samples composing a restored image.

The post-filtering unit 630 may perform an inverse interpolation filtering operation as an inverse conversion of the pre-filtering unit 530 which performs a phase shift filtering operation on odd numbered pixels composing the enhancement layer input image. For instance, the post-filtering unit 630 may restore the pixels 1021, 1023, 1025, and 1027 of the enhancement layer output image using the pixels 1011, 1013, 1015, and 1017 of the enhancement layer restored image which are prediction values of pixels of the base layer input image.

For instance, when the pre-filtering unit 530 according to an exemplary embodiment performs an interpolation filtering operation adding the same weight to continuous pixels of the enhancement layer input image, an inverse interpolation filtering operation of the post-filtering unit 630 may conform to the following Equation 4. Each pixel value of the pixels 1011, 1013, 1015, and 1017 composing the enhancement layer restored image encoded from an enhancement layer bitstream is expressed as ‘Y[n]’, and each pixel value of the pixels 1021, 1023, 1025, and 1027 of the enhancement layer output image outputted through a post-filtering operation on the enhancement layer restored image is expressed as ‘Xo[n]’, where n is 0 or a positive integer smaller than or equal to L.

Xo[L−1]=Y[L−1]

Xo[L−2]=2*Y[L−2]−Xo[L−1]

Xo[L−3]=2*Y[L−3]−Xo[L−2]

Xo[L−4]=2*Y[L−4]−Xo[L−3] [Equation 4]

When each pixel value of the pixels 1022, 1024, 1026, and 1028 of the base layer output image decoded from a base layer bitstream is expressed as ‘Xe[n]’, the pixel value may have a value similar to the pixel value Y[n] of the enhancement layer restored image.

Therefore, through the post-filtering unit 630, the pixels 1021, 1023, 1025, and 1027 of the enhancement layer output image corresponding to odd numbered pixels of a restored image may be correctly restored.

The base layer decoding unit 210 may restore the pixels 1022, 1024, 1026, and 1028 which are samples of the base layer output image corresponding to even numbered pixels of a restored image. Therefore, the pixels 1021, 1023, 1025, and 1027 of the enhancement layer output image compose odd numbered pixels of one of a first restored image and a second restored image, and the pixels 1022, 1024, 1026, and 1028 of the base layer output image compose even numbered pixels of the restored image for outputting the restored image.

Although it has been described above with reference to FIGS. 7 to 10 that the pre-filtering unit 530 and the post-filtering unit 630 according to various exemplary embodiments adopt a phase shift filtering operation and an interpolation filtering operation using characteristics of high spatial correlation between neighboring columns of a base layer and an enhancement layer, the pre-filtering and the post-filtering are not limited thereto. That is, the pre-filtering unit 530 and the post-filtering unit 630 may adopt various filtering methods without limitation to improve the performance of inter-layer prediction using a correlation between an image of a base layer and an image of an enhancement layer.

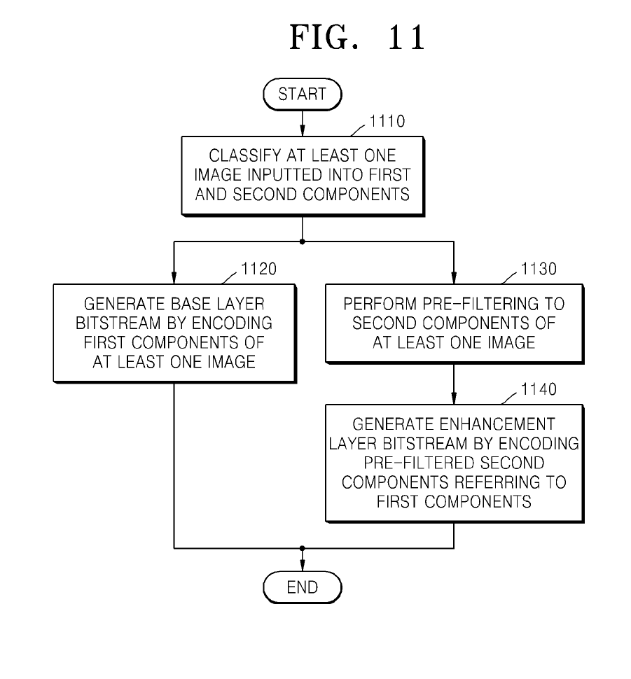

FIG. 11 is a flowchart illustrating a video encoding method according to an exemplary embodiment.

In operation 1110, at least one image is inputted, and first components and second components are classified for each of the at least one image. An image may be inputted picture-by-picture and frame-by-frame to be encoded. For instance, at least one image may include a time sequence of an image, at least one multiview image captured from at least one different view, and a 3D image composed of a left-view image and a right-view image. Furthermore, spatial data may be sampled for each image to be classified into odd numbered columns or rows and even numbered columns or rows.

In operation 1120, the first components classified from the at least one image are encoded as a base layer to generate a bitstream. A base layer input image composed of first components extracted from two or more images may be encoded to generate a base layer bitstream.

In operation 1130, a pre-filtering operation is performed on the second components classified from the at least one image using a correlation with the first components. For instance, when the first components and the second components are odd numbered columns or rows and even numbered columns or rows of an input image, respectively, a phase shift filtering operation may be performed using high spatial correlation and phase difference between the first components and the second components. Therefore, an enhancement layer filtered image composed of prediction values of a base layer input image of which a phase difference with the base layer input image is compensated for may be output by performing a phase shift filtering operation on an enhancement layer input image composed of the first components and the second components of an input image.

In operation 1140, an enhancement layer bitstream is generated by predictively encoding the pre-filtered second components by referring to the first components. Because inter-layer prediction is performed between an enhancement layer filtered image in which spatial correlation with a base layer input image has been improved through a pre-filtering operation, and the base layer input image, prediction performance may be improved.

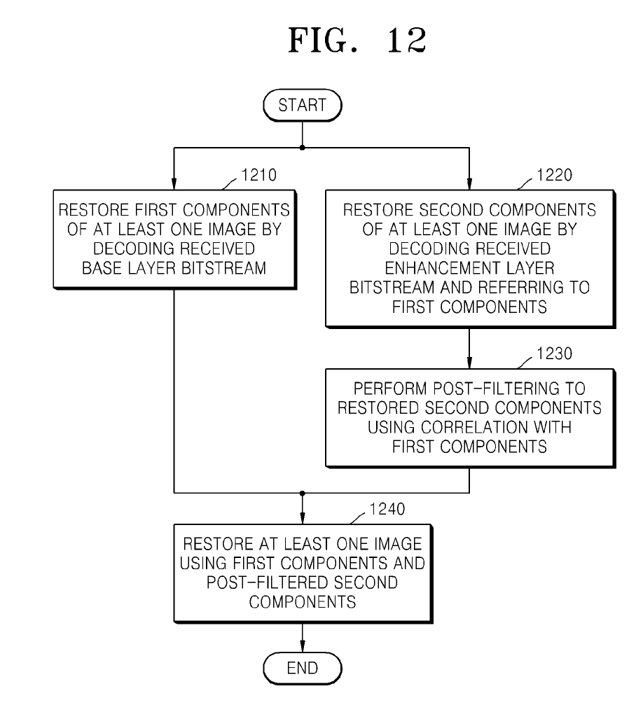

FIG. 12 is a flowchart illustrating a video decoding method according to an exemplary embodiment.

A base layer bitstream is decoded to restore first components of at least one image by parsing a received bitstream in operation 1210, and an enhancement layer bitstream is decoded and second components of at least one image are restored from the decoded enhancement layer bitstream by referring to the first components in operation 1220.

For instance, the received bitstream may be obtained by encoding a time sequence of an image, at least one multiview image captured from at least one different view, and a 3D image composed of a left-view image and a right-view image. Data restored from a base layer bitstream and data restored from an enhancement layer bitstream may be first components and second components composing a restored image, respectively.

For instance, the data restored from a base layer bitstream and an enhancement layer bitstream may correspond to pixel components of odd numbered columns or rows and even numbered columns or rows, respectively, of a restored image. Also, data restored from first regions of a base layer bitstream and an enhancement layer bitstream may correspond to pixel components of odd numbered columns or rows and even numbered columns or rows, respectively, of a first restored image, and data restored from second regions of a base layer bitstream and an enhancement layer bitstream may correspond to pixel components of odd numbered columns or rows and even numbered columns or rows, respectively, of a second restored image.

In operation 1230, a post-filtering operation is performed on the second components restored from the enhancement layer bitstream using a correlation with the first components. By inverse-filtering the filtered second components as an inverse process of a pre-filtering operation of an encoding stage for improving correlation with first components, second components complementary to first components may be restored.

For instance, in the case that a phase shift filtering operation has been performed as a pre-filtering operation at an encoding stage for compensating for a phase difference between first components and second components, by restoring a phase difference between the first and second components for data decoded from an enhancement layer bitstream, the second components may be restored.

In operation 1240, at least one image is restored using the first components restored from the base layer bitstream, and the second components restored through the post-filtering operation after being decoded from the enhancement layer bitstream. An image may be inputted picture-by-picture and frame-by-frame to be decoded.

Therefore, according to a video encoding method according to an exemplary embodiment, because data of multiple images such as a 3D image are synthesized as a single image and encoded, the method is compatible with a related art video encoding/decoding system which encodes/decodes a video frame-by-frame or picture-by-picture. Also, because data of multiple images are synthesized as a single image and encoded in a base layer so that omitted image data may be transmitted through a separate layer, multiple images may be restored to have the same resolutions as original images if encoded bitstreams of all layers are received during a decoding operation.

The above-described exemplary embodiments may be programmed to be executed by a computer, and may be implemented in a general digital computer which executes the program using a computer-readable recording medium. The computer-readable recording medium includes magnetic storage media (e.g., ROM, floppy disks, hard disks, etc.) and optical recording media (e.g., CD-ROMs, or DVDs). Moreover, one or more units of the video encoding device 100 and the video decoding device 200 may include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the present invention as defined by the following claims.

What is claimed is:

1. A method of video encoding for encoding an image synthesized from at least one image, the method comprising:
generating a base layer bitstream by encoding first components of the at least one image;
pre-filtering second components, different from the first components, of the at least one image using a correlation between the first components and the second components; and
generating an enhancement layer bitstream by encoding the pre-filtered second components with reference to the first components.

2. The method of claim 1, wherein the at least one image comprises at least one multiview image captured from at least one different view as compared to a corresponding image.

3. The method of claim 2, wherein:
the first components of the at least one image comprise a combination of odd numbered columns of a first image and even numbered columns of a second image corresponding to the first image, or a combination of odd numbered rows of the first image and even numbered rows of the second image; and
the second components of the at least one image comprise a combination of even numbered columns of the first image and odd numbered columns of the second image, or a combination of even numbered rows of the first image and odd numbered rows of the second image.

4. The method of claim 3, wherein the first image is a left-view image and the second image is a right-view image corresponding to the left-view image.

5. The method of claim 1, wherein the pre-filtering of the second components comprises phase shift filtering for compensating for a phase difference between the first components and the second components of a same image.

6. The method of claim 5, wherein the phase shift filtering comprises interpolation filtering for neighboring samples in the second components.

7. The method of claim 1, wherein the pre-filtering of the second components comprises generating prediction values of the first components from the second components based on the correlation between the first components and the second components through pre-filtering of the second components.

8. The method of claim 1, wherein the generating of the enhancement layer bitstream comprises encoding residual data by performing inter-layer prediction on the pre-filtered second components with reference to the first components.

9. A method of video decoding for decoding an image synthesized from at least one image, the method comprising:
restoring first components of the at least one image by decoding a received base layer bitstream;
restoring second components, different from the first components, of the at least one image by decoding a received enhancement layer bitstream and referring to the restored first components; and
post-filtering the restored second components using a correlation between the first components and the second components.

10. The method of claim 9, further comprising restoring the at least one image using the restored first components and the post-filtered second components.

11. The method of claim 9, wherein the at least one image comprises at least one multiview image captured from at least one different view as compared to a corresponding image.

12. The method of claim 11, wherein:
the first components of the at least one image comprise a combination of odd numbered columns of a first image and even numbered columns of a second image corresponding to the first image, or a combination of odd numbered rows of the first image and even numbered rows of the second image; and
the second components of the at least one image comprise a combination of even numbered columns of the first image and odd numbered columns of the second image, or a combination of even numbered rows of the first image and odd numbered rows of the second image.

13. The method of claim 12, wherein the first image is a left-view image and the second image is a right-view image corresponding to the left-view image.

14. The method of claim 9, wherein the post-filtering of the restored second components comprises phase shift filtering for compensating for a phase difference between the first components and the second components of a same image.

15. The method of claim 14, wherein the phase shift filtering comprises inverse interpolation filtering for neighboring samples in the restored second components.

16. The method of claim 9, wherein the post-filtering of the restored second components comprises generating pixels of an enhancement layer output image through post-filtering of the restored second components when the restored second components are prediction values of the first components based on the correlation between the first components and the second components.

17. The method of claim 9, wherein the decoding of the enhancement layer bitstream comprises reconfiguring the second components by performing inter-layer prediction on residual data between the first components and the second components extracted from the enhancement layer bitstream with reference to the first components.

18. A video encoding device for encoding an image synthesized from at least one image, the device comprising:
a layer component classifying unit configured to classify components of the at least one image into first components and second components, different from the first components;
a base layer encoding unit configured to generate a base layer bitstream by encoding the first components of the at least one image;
a pre-filtering unit configured to perform pre-filtering on the second components of the at least one image using a correlation between the first components and the second components; and
an enhancement layer encoding unit configured to generate an enhancement layer bitstream by encoding the pre-filtered second components with reference to the first components, and

19. The device of claim 18, wherein the layer component classifying unit is configured to sample the at least one image and to classify the components of the sampled at least one image into the first components and the second components.

20. The device of claim 18, wherein:
the first components of the at least one image comprise a combination of odd numbered columns of a first image and even numbered columns of a second image corresponding to the first image, or a combination of odd numbered rows of the first image and even numbered rows of the second image; and
the second components of the at least one image comprise a combination of even numbered columns of the first image and odd numbered columns of the second image, or a combination of even numbered rows of the first image and odd numbered rows of the second image.

21. A video decoding device for decoding an image synthesized from at least one image, the device comprising:
a base layer decoding unit configured to decode a received base layer bitstream and restore first components of the at least one image;
an enhancement layer decoding unit configured to decode a received enhancement layer bitstream and restore second components, different from the first components, of the at least one image by referring to the restored first components;
a post-filtering unit configured to perform post-filtering to the restored second components using a correlation between the first components and the second components; and
an image restoring unit configured to restore the at least one image using the restored first components and the post-filtered second components.

22. The device of claim 21, wherein:
the first components of the at least one image comprise a combination of odd numbered columns of a first image and even numbered columns of a second image corresponding to the first image, or a combination of odd numbered rows of the first image and even numbered rows of the second image; and
the second components of the at least one image comprise a combination of even numbered columns of the first image and odd numbered columns of the second image, or a combination of even numbered rows of the first image and odd numbered rows of the second image.

23. A method of video decoding for decoding an image synthesized from at least one image, the method comprising:
restoring second components of the at least one image by decoding an enhancement layer bitstream and referring to first components, different from the second components, of the at least one image; and
post-filtering the restored second components using a correlation between the first components and the second components.

24. A computer-readable recording medium on which a computer executable program is recorded to implement a video encoding method of claim 1.

25. A computer-readable recording medium on which a computer executable program is recorded to implement a video decoding method of claim 9.

26. A computer-readable recording medium on which a computer executable program is recorded to implement a video decoding method of claim 23.
